(19) United States
(12) Patent Application Publication
(10) Pub. No.: US 2016/0337688 A1
(43) Pub. Date: Nov. 17, 2016

(54) Systems and Methods of Time Shifted Rewind

(71) Applicant: COX COMMUNICATIONS, INC., Atlanta, GA (US)

(72) Inventors: Malcolm Eruteya, Atlanta, GA (US); Robert Clark Whitten, Kennesaw, GA (US)

(73) Assignee: COX COMMUNICATIONS, INC., Atlanta, GA (US)

(21) Appl. No.: 14/713,651

(22) Filed: May 15, 2015

(51) Int. Cl. H04N 21/433; H04N 5/91

(52) U.S. Cl. CPC H04N 21/4334; H04N 5/91

(57) ABSTRACT

Systems and methods are disclosed for utilizing idle DVR content tuners including determining at least one content tuner is available, selecting the content tuner and tuning the at least one available tuner to a specified channel where the specified channel is determined at least in part by one or more stored user preferences and recording one or more content items on the selected channel.

### TECHNICAL FIELD

The present disclosure is generally related to making time-shifted content available and, more particularly, is related to capturing time-shifted content using idle tuner resources.

### BACKGROUND

Currently, if a user does not program a digital video recorder (DVR) to record a specific activity or content item, then one or more DVR tuners may sit idle. While a variety of content recording options are available to a user of a DVR, such as remote scheduling via a smartphone app, setting up a season pass, and the like, it is still possible for a viewer to miss content that they want to see.

Some types of content are transitory and resistant to being recorded via scheduling in advance or by season pass. For example, since breaking news stories fails to adhere to any preset schedule, this type of content is highly resistant to pre-scheduled recording options such as setting up a season pass.

Some DVR devices include a channel recording buffer, which provides a user with some playback options, albeit limited ones. One drawback to the conventional channel recording buffer is that while it allows the user to at least partially rewind a program that is already underway, the recording buffer can only do so if the DVR has previously been tuned to the channel with the program already underway beforehand.

Despite the conveniences afforded by DVR devices, it is still possible for a viewer to miss content that viewer would like to see. There are heretofore unaddressed needs with previous solutions.

### SUMMARY

Example embodiments of the present disclosure provide systems for utilizing idle DVR tuners. Briefly described, in architecture, one example embodiment of the system, among others, can be implemented as follows: a processor with computer readable medium with a set of instructions operable to determine at least one content tuner is available, select the at least one available content tuner, tune the at least one available content tuner to a specified channel wherein the specified channel is determined by one or more stored user preferences, and record one or more content items on the specified channel.

Embodiments of the present disclosure can also be viewed as providing systems for utilizing idle DVR tuners. Briefly described, in architecture, one example embodiment of the system, among others, can be implemented as follows: a processor comprising a computer readable medium with a set of instructions operable to select at least one available tuner, tune the at least one available tuner to a specified channel wherein the specified channel is determined by one or more stored user preferences, record the specified channel content, and generate a program guide comprising scheduled content data wherein an indicator is displayed next to each scheduled content item where recorded channel content is available.

According to still yet another embodiment of the present disclosure, example embodiments of the present disclosure provide systems for utilizing idle DVR tuners that can be implemented as follows: a processor comprising a computer readable medium with a set of instructions operable to determine at least one tuner is available, select the at least one available tuner, tune the at least one available tuner to a specified channel wherein the specified channel is determined by one or more stored user preferences selected from the group consisting a channel id, a content type, a time of day and, a day of week, and record one or more content items on the specified channel.

### BRIEF DESCRIPTION OF THE DRAWINGS

FIG. 1 illustrates an example environment in which an embodiment in accordance with the present disclosure may be practiced.

FIG. 2 illustrates an example system for supporting provision of a time shifted content rewind system according to an example embodiment of the disclosure.

FIG. 3 schematically illustrates an electronic program guide presented to a viewer in accordance with an example embodiment of the disclosure.

FIG. 4 schematically illustrates an electronic program guide presented to a viewer in accordance with an alternate example embodiment of the disclosure.

FIG. 5 schematically illustrates an information screen showing content recorded in accordance with an example embodiment of the disclosure.

FIG. 6 is a block diagram illustration of a method in accordance with an example embodiment of the disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following description, numerous details are set forth to provide an understanding of the present disclosure. However, it will be understood by those of ordinary skill in the art that the present disclosure may be practiced without these details and that numerous variations or modifications from the described embodiments may be possible. The disclosure will now be described with reference to the figures, in which like reference numerals refer to like, but not necessarily the same or identical, elements throughout. For purposes of clarity in illustrating the characteristics of the present disclosure, proportional relationships of the elements have not necessarily been maintained in the figures.

According to an example embodiment of the disclosure, an electronic listing includes a visual indicator, such as an icon or text, next to the program title indicating that an earlier portion of the show is available.

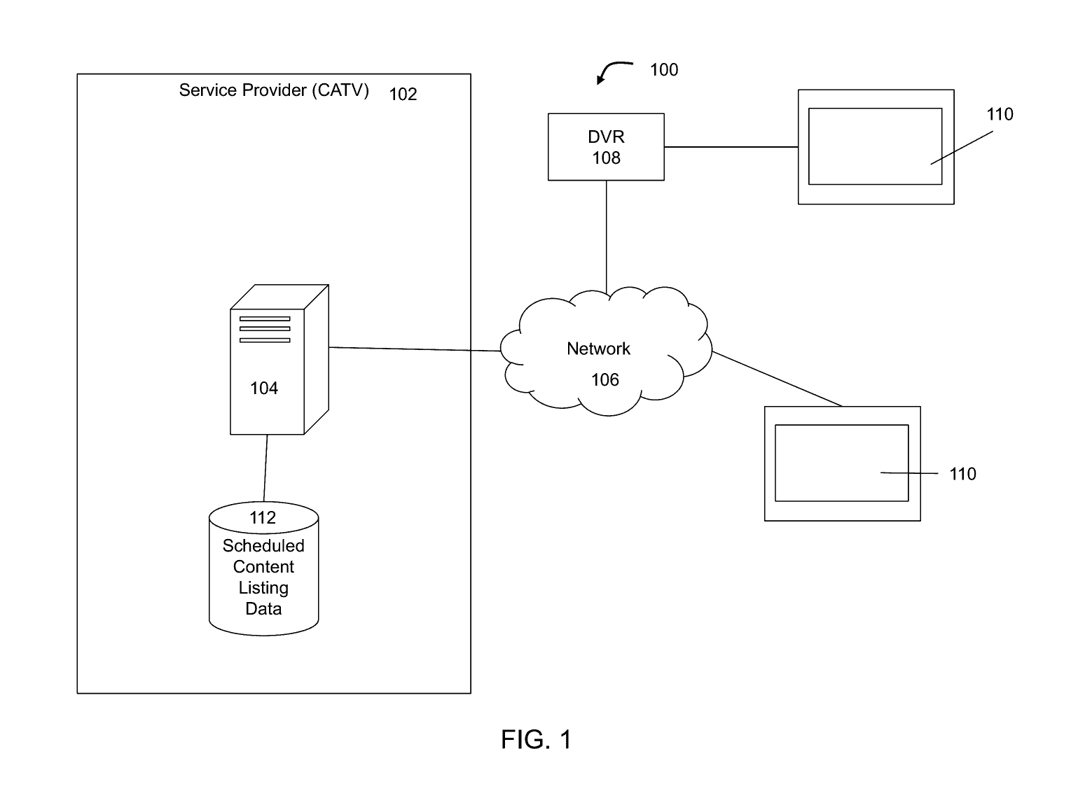

Referring now to the drawings in which like numerals represent like elements or steps throughout the several views, FIG. 1 is block diagram of example environment 100 for providing a system for content time shift rewinding in accordance with the present disclosure. Example environment 100 may comprise service provider 102, such as a Cable Television service provider (CATV), that includes service provider server 104 attached via network 106 to one or more data repositories including scheduled content listing data 112.

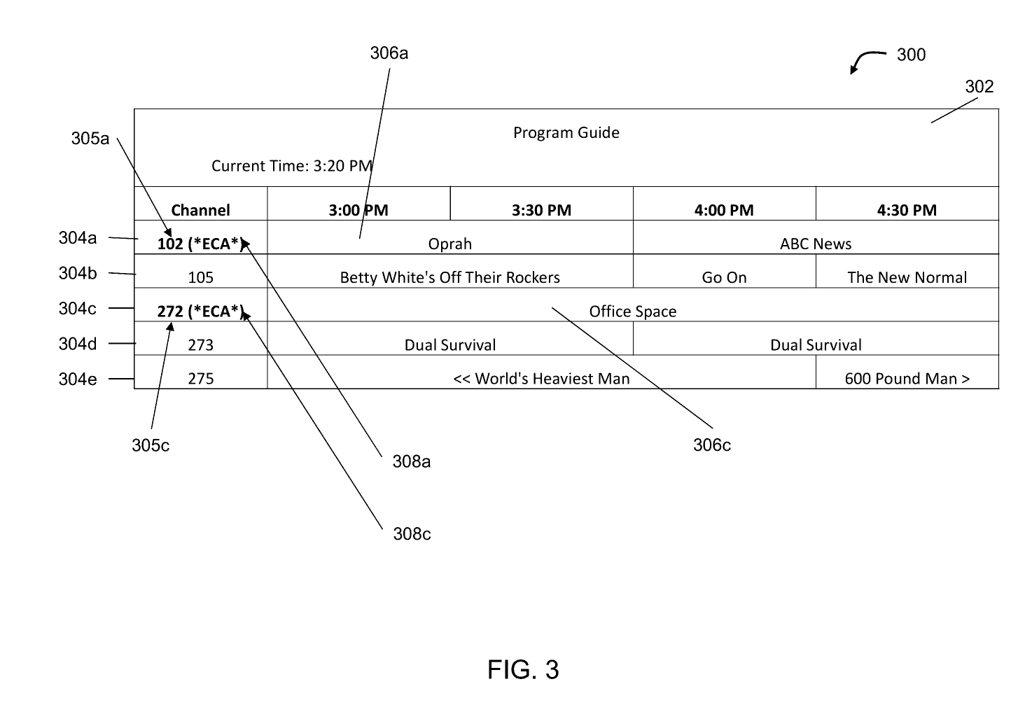

Content from service provider 102 may be transmitted for distribution over network 106 to DVR 108 and one or more display devices 110. Content may either be sent directly to display device 110 or sent to DVR 108 for use on display device 110. Examples of content include audio, video, and/or other data and/or signals and an electronic program guide as depicted in FIGS. 3, 4, and 5.

It will be appreciated by one of ordinary skill in the art that the terms DVR and set top box (STB) may be used interchangeably herein. It will further be appreciated that DVR/STB as used herein may include one or more devices used in standalone, tandem, or multiple devices in a master-subordinate arrangement.

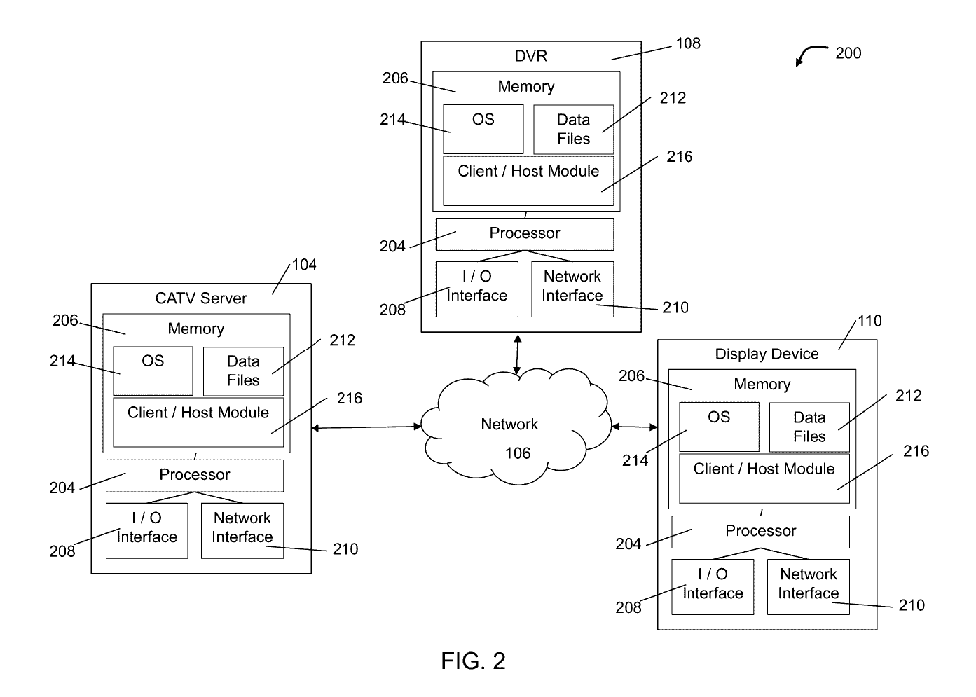

In an example embodiment, service provider server 104 may process and provide information from scheduled content listing data repository 112 to generate electronic guide data associated with program content. Server 104 may include a graphics library associated with providing design information associated with layout, fonts, colors, and the like that are associated with the electronic program guide such as a carousel server. Service provider server 104 may comprise a computing device as described below with respect to FIG. 2. Consistent with embodiments of the disclosure, service provider server 104 may comprise one or more software applications (i.e., a series of instructions configured for execution by a processing unit) associated with another component, such as one or more servers or dedicated content devices.

Network 106 (also referred herein as distribution network or communication network) is, generally, used and implemented by a cable service provider (such as, but not limited to, a wired and/or wireless communication service provider) to enable the service provider to provide, and the service provider's subscribers to receive content and communication services. Network 106 additionally refers to infrastructure, including apparatuses and methods, operative and utilized to communicate data and/or signals between networked devices such as service provider server 104, DVR 108, and display device 110. Similarly, for example and not limitation, network 106 may include current and future wired and/or wireless communication infrastructure for communicating video, audio, or other data and/or signals such as the public switched telephone communication network, cable and/or satellite telecommunications service provider communication networks, other service provider communication networks, and the Internet.

Additionally, network 106 may include any telecommunication and/or data network, whether public, private, or a combination thereof, including a local area network, a wide area network, an intranet, an internet, the Internet, intermediate hand-held data transfer devices, and/or any combination thereof and may be wired and/or wireless. Network 106 may also allow for real-time, off-line, and/or batch transactions to be transmitted between or among service provider server 104, DVR 108, and display device 110. Due to network connectivity, various methodologies as described herein may be practiced in the context of distributed computing environments.

Although DVR 108 is shown for simplicity in an example embodiment as being in communication with service provider server 104 via one intervening network 106, it is to be understood that other network configurations may be used. For example, intervening network 106 may include a plurality of networks, each with devices such as gateways and routers for providing connectivity between or among networks. Instead of, or in addition to network 106, dedicated communication links may be used to connect the various devices in accordance with example embodiments of the disclosure. For example, DVR 108 may form the basis of network 106 that interconnects one or more display devices 110. As shown in FIG. 1, service provider 102 components including service provider server 104, DVR 108, and display device 110 may be in communication with each other via a network such as network 106, which as described herein can include one or more separate or shared private and public networks, including the Internet or a publicly switched telephone network.

DVR 108 may include a stand alone or integrated devices such as a PC, media server, television tuner, satellite or cable receiver, digital video recorder, video game console, Blu-ray player, tablet, smart device, and the like. Display device 110 may include one or more of video playback screen, tablet device, smart phone, PDA, or other device with one or more connectivity options. Display device 110 may also include LCD display devices such as a monitor featuring an operating system, media browser, and the ability to run one or more software applications. Display device 110 may also include the same features and functionality of DVR 108.

Service provider server 104 is shown in communication with data repository scheduled content listing data 112. It will be appreciated that the terms broadcast, scheduled, and linear are used interchangeably herein as applied to content. It will further be appreciated that content, television program, show, movie, video, audio, picture and the like are used interchangeably herein as well. By way of example and not limitation, scheduled content listing data may include program title, episode number, running length, channel, date, start time, ratings, and synopsis summary. Scheduled content listing information may be stored in any computer readable form. Additionally, it will be appreciated by those of ordinary skill in the art that scheduled content program information may include information guide data from one or more sources such as obtaining guide data from Tribune Media Services.

FIG. 2 illustrates example system 200 for supporting provision of a time shifted content rewind system according to an example embodiment of the disclosure. Service provider server 104, DVR 108, and display device 110 may be any processor-driven device, such as, but not limited to, a personal computer, laptop computer, handheld computer, dedicated processing device, and/or an array of computing devices. In addition to having processor 204, server 104, DVR 108, and display 110 may further include memory 206, input/output (“I/O”) interface(s) 208, and network interface 210. Memory 206 may be any computer-readable medium, coupled to the processor, such as RAM, ROM, and/or a removable storage device for storing data files 212 and a database management system (“DBMS”) to facilitate management of data files 212 and other data stored in memory 206 and/or stored in separate databases. Memory 206 may store data files 212 and various program modules, such as operating system (“OS”) 214 and client module 216. OS 214 may be, but is not limited to, Microsoft Windows®, Apple OS X®, Unix, Oracle Java®, Linux, Android, or a mainframe operating system. Client module 216 may be an Internet browser or other software, including a dedicated program, for interacting with server 104, network 106, DVR 108, and/or display device 110.

Suitable processors, such as processors 204 of service provider server 104, DVR 108, and display device 110, respectively, may comprise a microprocessor, an ASIC, and/or a state machine. Example processors may include those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein.

Generally, each of the memories and data storage devices, such as memories 204 and database 112 (as shown in FIG. 1), and/or any other memory and data storage device, can store data and information for subsequent retrieval. In this manner, systems may store various received or collected information in memory or a database associated with service provider server 104, DVR 108, and/or display device 110. The memories and databases may be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown may be integrated or distributed into any number of databases or other data storage devices.

As used herein, the term “computer-readable medium” may describe any form of memory or a propagated signal transmission medium. Propagated signals representing data and computer program instructions may be transferred between network devices and systems. Embodiments of computer-readable media include, but are not limited to, electronic, flash, optical, magnetic, or other storage or transmission device capable of providing a processor with computer-readable instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Generally, network devices and systems, service provider server 104, DVR 108, and display device 110 have hardware and/or software for transmitting and receiving data and/or computer-executable instructions over a communications link and a memory for storing data and/or computer-executable instructions. These network devices and systems may also include a processor for processing data and executing computer-executable instructions locally and over network 106, as well as other internal and peripheral components that are well known in the art.

Still referring to service provider server 104, DVR 108, and display 110, I/O interface(s) 208 may facilitate communication between processor 204 and various I/O devices, such as a keyboard, mouse, printer, microphone, speaker, monitor, bar code readers/scanners, RFID readers, and the like. Network interface 210 may take any of a number of forms, such as a network interface card, a modem, a wireless network card, and the like. It will be appreciated that while service provider server 104, DVR 108, and display 110 have been illustrated as a single computer or processor, service provider server 104, DVR 108, and display 110 may be comprised of a group of computers or processors, according to an example embodiment of the disclosure.

As previously mentioned, network 106 may takes many forms, including a public and/or a private network, such as a cable television distribution network (e.g., a hybrid fiber-coax network), a cellular data network, a metropolitan WiMAX network, and/or the Internet.

Exemplary environment 100 shown in and described with respect to FIGS. 1 and 2 are provided by way of example only. Numerous other operating environments, system architectures, and device configurations are possible. Other system embodiments can include fewer or greater numbers of components and may incorporate some or all of the functionality described with respect to the system components shown in FIGS. 1 and 2.

For example, in one embodiment, service provider server 104 (or DVR 108/ display device 110) may be implemented as a specialized processing machine that includes hardware and/or software for performing the methods described herein. In addition, the processor and/or processing capabilities of service provider server 104, may be implemented as part of DVR 108, display device 110, or any portion or combination thereof. Accordingly, embodiments of the disclosure should not be construed as being limited to any particular operating environment, system architecture, or device configuration.

FIG. 3 is an illustration of an example embodiment of electronic program guide 300. Electronic program guide 300 may be provided by CATV service provider 102, and will show scheduled content listing information. As shown, guide 300 includes heading row 302 and a multiple channel information rows 304a-e. Each of channel information rows 304a-e features a channel identifier such as 305a and c and program and schedule information, such as program content entry 306a and c. Channel identifier 304 may comprise a physical and/or a virtual channel number (e.g., the channel number a viewer may input into DVR 108 and/or one of display device 110 to tune to that channel). Program content entry 306a-e includes information associated with the program such as a title, actors, genre, episode description, and/or duration.

As shown, indicators 308a and 308c are present next to channel identifiers 305a and 305c shown in electronic guide 300 to inform the viewer that earlier portions of the shows on those channels that are already in progress (“Oprah” and “Office Space”) are available for viewing. While indicator 308a reads “(ECA)” and indicator 308c reads “(ECA)”, other sorts of indicators such as an icon, abbreviation, highlighting, or changes in font or background color may be used to indicate that earlier portions of already in progress content is available viewing.

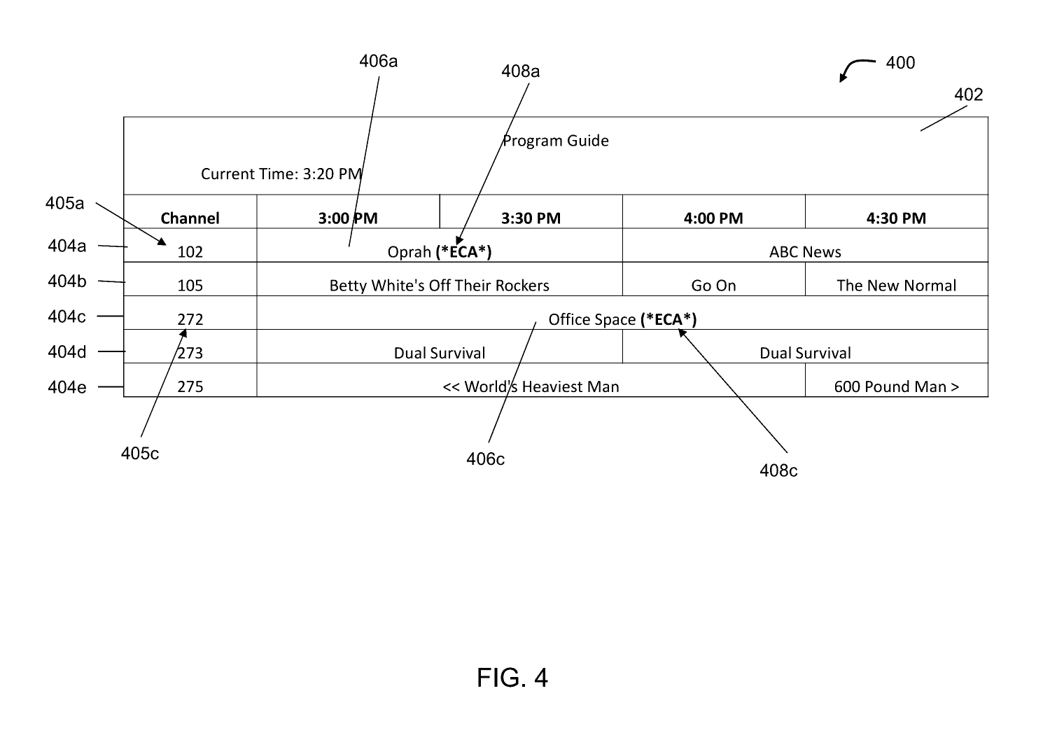

FIG. 4 illustrates an example embodiment of an electronic program guide 400 presented to a viewer. As discussed, guide 400 includes heading row 402 and several channel information rows 404a-e. Each of channel information rows 404a-e shows a channel identifier such as 405a and 405c in addition to program and schedule information, such as program content entries 406a and 406c. Program content entries 406a and 406c may be formatted with font and/or color information, such as by assigning a background color according to a genre of the content.

Electronic program guide 400 includes information for scheduled content listings. As shown, indicators 408a and 408c are present next to the scheduled program titles 406a and 406c shown in electronic guide 400 to inform the viewer that earlier portions of the already in progress “Oprah” and “Office Space” shows are available for viewing. While indicator 408a reads “(ECA)” and indicator 408c reads “(ECA)”, other sorts of indicators such as an icon, abbreviation, highlighting, or changes in font or background color may be used to indicate that earlier portions of the content is available viewing.

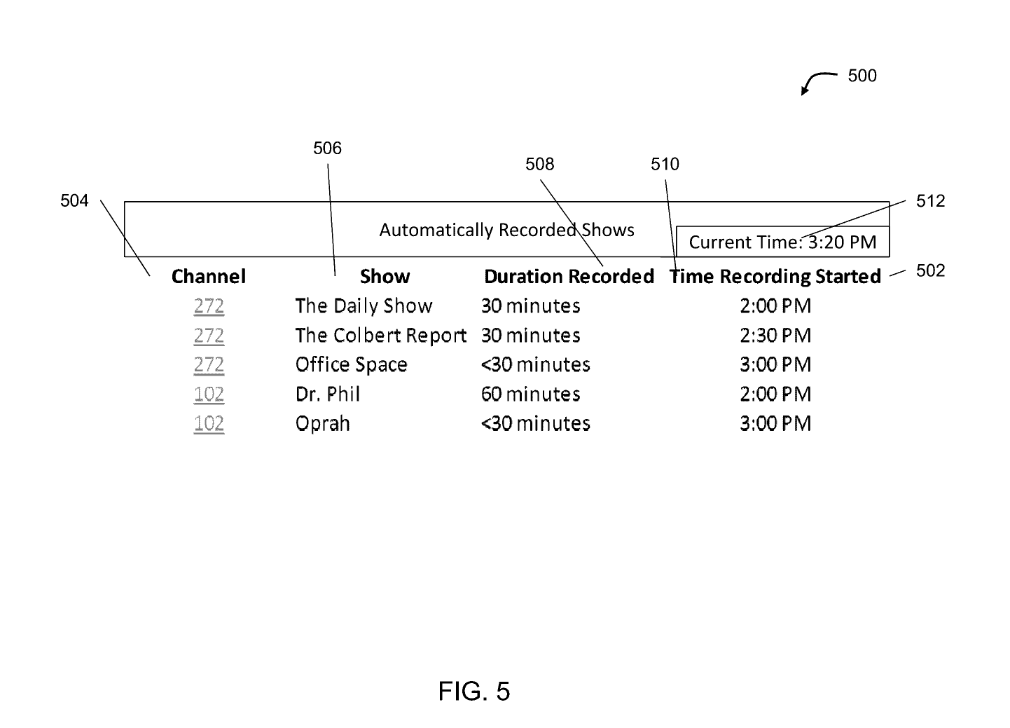

FIG. 5 schematically illustrates an example embodiment of information screen 500 presented to a viewer. Information screen 500 indicates that content items have been recorded using idle/available tuners. As shown, heading row 502 includes channel column 504, along with content title column 506, duration recorded column 508, and time recording started column 510. Also shown is current time 512. Duration recorded column 508 indicates the length of the recording while time started column 510 indicates the time that the recording began.

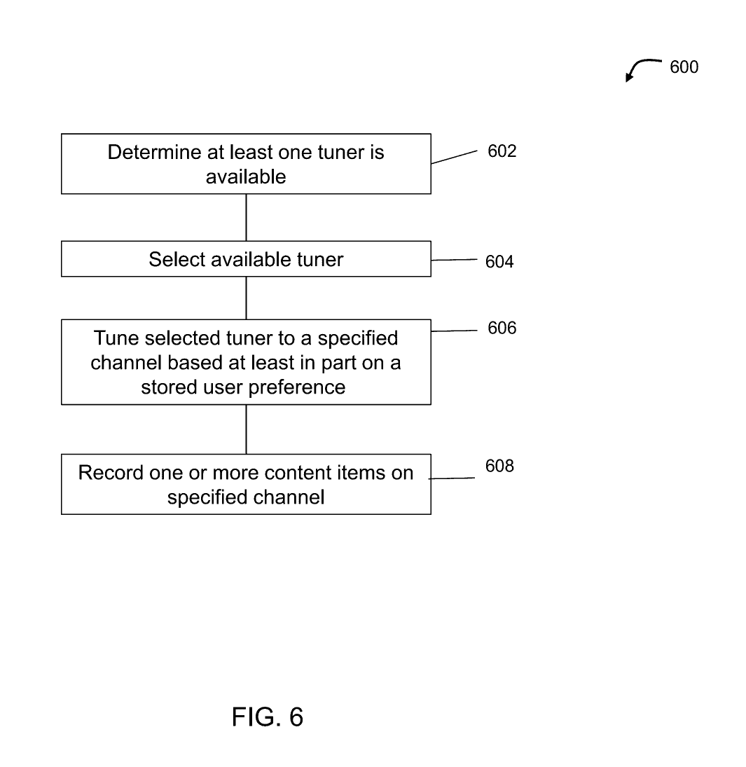

FIG. 6 is a block diagram illustration of an example embodiment of instructions 600 for providing a time shifted content rewind system. In block 602, the system determines at least one tuner is available. In block 604, the system selects the available tuner. In block 606, the system tunes the selected tuner to a specified channel based at least in part on a stored user preference. In block 608, the system records one or more content items on the specified channel.

According to one aspect of the present disclosure, set of instructions 600 for a system is provided which permits a user to specify what should be recorded when DVR resources are idle or otherwise unused. By utilizing idle DVR resources, the system permits a user to view content that would ordinarily not be recorded or otherwise be available for viewing after the content has been shown at its regularly scheduled time. As shown in block 602, the system determines that at least one tuner is available. The terms tuner, digital tuner, and content tuner are used interchangeably herein. It will be appreciated by one of ordinary skill in the art that while the above examples include the use of one or more available tuner resources, the disclosure is not limited to DVR tuners and includes additional video storage solution resources such as available bandwidth and the like. Additionally, the one or more tuners described herein may be in a single device or multiple devices with a controller and one or more subordinate devices.

In block 604, the system selects the available tuner. It should be noted that some DVR units include multiple tuners and that each DVR tuner is capable of tuning to and recording a unique channel (signal carrier) at the same time. For example, instructions 600 are employed on a DVR with six digital tuners of which four of the tuners are in use (watching/consuming live content on different channels). Where no other recordings have been scheduled, the system determines that two idle tuners are available per block 602. Per block 604, the system selects one of the available tuners.

In block 606, the system tunes the selected tuner to a specified channel based at least in part on a stored user preference. It will be appreciated that according to some embodiments of the present disclosure, the system tunes the selected tuner to a specified channel based in part on one or more stored user preferences. Examples of stored user preferences include but are not limited to channel id, time of day (TOD), day of week (DOW), content type, content rating, maturity rating, quantity of active recordings, associate/friend activity, and/or any combination thereof.

Continuing the above example, there are two idle content tuners that are available on the DVR for use by the system to record content. If the stored user preference includes a channel id, then any time a content tuner is idle, the system will select an available tuner 604 and tune the content tuner to a specified channel as in block 608 based on the following example list of prioritized channels:
1) Comedy Central (Channel 272)
2) ABC (Channel 102)
3) ESPN (Channel 543)
4) CNN (Channel 333)
5) FX (Channel 278)
6) HBO (Channel 669)

As shown, the stored user preference indicates that the user has chosen channel IDs and prioritized the order of those chosen channels IDs to record with the first listed channel 1) Comedy Central given the highest priority and the last listed channel 6) HBO given the lowest priority. In the scenario above, with two idle tuners available, the system tunes to Comedy Central on the first available tuner based on the stored user preference in block 606 and begins recording the content in block 608. Additionally, since a second tuner is available, the system tunes the second available tuner to ABC based on the stored user preference in block 606 and begins recording the content in block 608. In the event a third tuner becomes available, the system will tune to ESPN based on the stored user preference in block 606 and begin recording the content in block 608.

Other stored user preferences examples, in addition to the ability to specify a prioritized list of channel ids, include combinations thereof, such as specifying which channel IDs to record based on the time of day and/or day of week. For instance, if the user normally gets home at 6:30 pm Monday through Friday (during the week), then the stored user preferences may instruct the system to tune and record ABC on the first available tuner, since the user may want to be able to see the 6 pm local news, even if the user does not get home until 6:30 pm. However, according to another stored user preference, on a Saturday evening, between 6 pm and 10 pm, the system may be instructed to tune and record HBO on at least one available content tuner.

Other stored user preference examples may direct the system to record channels and content based on content type. In this scenario, a stored user preference indicates that idle tuners should record content based on the description as one or more of the following: Sports, Drama, Comedy, Religious, or News.

According to yet another aspect of the present disclosure, stored user preferences may specify the quantity, ratio, or maximum quantity of active recordings to be stored/recorded by the system based on the type of content. For instance, if all six tuners are available, the user could specify a maximum of two Sports shows, three Drama shows, and one Comedy show be recorded at a time. It will be appreciated by one of ordinary skill in the art that a stored user preference based on content type may be combined with other scheduling capabilities of the system, which could further affect which shows are recorded such as current or future season passes and/or scheduled recordings.

Another stored user preference type may configure the system to record channels using available tuners based on a maturity rating such as those set forth in a standardized television content rating system. In this scenario, the user could specify that idle tuners should record content with a “TV-MA” rating, or more specifically, content with a “TV-MA LSV” ratings. Sample ratings for the US include those provided at: http://en.wikipedia.org/wiki/Television_content_rating_systems

Other stored user preferences direct the system to record channels using available tuners based on user ratings, which could be combined with time of day and day of week capability. In this scenario, the user could specify that idle tuners should record content with a “*****” (5 Star) rating.

Another example embodiment includes an option for prioritization to configure the system to record channels based on what one or more friends/associates (friends, family, co-workers, etc) is viewing or has scheduled to view/record.

In this scenario, the user could specify that idle tuners should record content where at least two other associates are watching or recording the same channel. Discovery and communication of what content friends/associates are currently watching or have scheduled to record may be discovered by one or more connected social media accounts, console buddy (such as XBOX live), gaming center ID or the like.

It will further be appreciated that according to another aspect of the present disclosure, stored user preferences may specify whether, or how long content recorded by the system described herein is retained.

According to the present disclosure, there are several ways to provide the user with access to content recorded by the system. For example, FIGS. 3 and 4 illustrate an electronic program guide with indicators that indicate that earlier content is available for viewing. Additionally, FIG. 5 illustrates an information screen that lists the content items that were recorded by the time shift rewind system in accordance with an embodiment of the present disclosure.

It will be appreciated by one of ordinary skill in the art that the steps/ instructions set forth in FIG. 6 may be performed on service provider server 104, DVR 108, or display device 110. Additionally, it should be noted that stored content data information may include both data stored or within the domain of service provider 102 and third party service provider stored content data that is available by virtue of a viewer's third party content subscription.

The flow chart of FIG. 6 shows the architecture, functionality, and operation of a possible implementation of providing time shift content rewind system. In this regard, each block represents a module, segment, or portion of code, which comprises one or more executable instructions for implementing the specified logical function(s). It should also be noted that in some alternative implementations, the functions noted in the blocks may occur out of the order noted in FIG. 6. For example, two blocks shown in succession in FIG. 6 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

1. A system for utilizing idle DVR content tuners comprising:
a processor comprising a computer readable medium with a set of instructions operable to:
determine at least one content tuner is available;
select the at least one available content tuner;
tune the at least one available content tuner to a specified channel determined by one or more stored user preferences; and
record one or more content items on the specified channel.

2. The system of claim 1, further comprising instructions to:
determine at least one additional content tuner is available;
select the at least one additional available content tuner;
tune the at least one additional available content tuner to a second specified channel wherein the second specified channel is determined by the one or more stored user preferences; and
record one or more content items on the second specified channel.

3. The system of claim 1, wherein the one or more stored user preferences are prioritized.

4. The system of claim 1, further comprising instructions to:
store the one or more recorded content items in accordance with at least one saved user preference.

5. The system of claim 1, wherein the one or more stored user preferences are selected from a group including channel ID, content type, time of day, and day of week.

6. The system of claim 1, where the one or more stored user preferences include a channel ID, a time of day, and a day of week.

7. A system for utilizing idle DVR tuners comprising:
a processor comprising a computer readable medium with a set of instructions operable to:
select at least one available tuner;
tune the at least one available tuner to a specified channel determined by one or more stored user preferences;
record the specified channel content; and
generate a program guide comprising scheduled content data with an indicator displayed next to each scheduled content item where recorded channel content is available.

8. The system of claim 7, further comprising instructions to:
select at least one additional available content tuner;
tune the at least one additional available content tuner to a second specified channel determined by the one or more stored user preferences; and
record one or more content items on the second specified channel.

9. The system of claim 7, wherein the one or more stored user preferences are prioritized.

10. The system of claim 7, further comprising instructions to:
store the one or more recorded content items in accordance with at least one saved user preference.

11. The system of claim 7, where the one or more stored user preferences are selected from a group including channel ID, content type, time of day, and day of week.

12. The system of claim 7, wherein the one or more stored user preferences include a channel ID, a time of day, and a day of week.

13. The system of claim 7, wherein the one or more stored user preferences include a channel ID and a time of day.

14. A method for utilizing idle DVR tuners comprising:
determining at least one tuner is available;
selecting the at least one available tuner;
tuning the at least one available tuner to a specified channel determined by one or more stored user preferences selected from a group including channel ID, content type, time of day, and day of week; and
recording one or more content items on the specified channel.

15. The method of claim 14, further comprising:
selecting at least one additional available content tuner;
tuning the at least one additional available content tuner to a second specified channel determined by the one or more stored user preferences; and
recording one or more content items on the second specified channel.

16. The method of claim 14, wherein the one or more stored user preferences are prioritized.

17. The method of claim 14, further comprising storing the one or more recorded content items in accordance with at least one saved user preference.

18. The method of claim 14, further comprising generating a program guide comprising scheduled content data with an indicator displayed next to each scheduled content item where recorded channel content is available.
